(19) United States
(12) Patent Application Publication
(10) Pub. No.: US 2010/0186767 A1
(43) Pub. Date: Jul. 29, 2010

(54) METHOD FOR REMOVING OIL FROM OIL-CONTAMINATED MATERIAL

(75) Inventor: Andrew Martin, Aberdeen (GB)

Correspondence Address: INTELLECTUAL PROPERTY / TECHNOLOGY LAW, PO BOX 14329, RESEARCH TRIANGLE PARK, NC, 27709, US

(73) Assignee: SEIMTEC LIMITED, Aberdeen (GB)

(21) Appl. No.: 12/671,350

(22) PCT Filed: Jul. 29, 2008
(86) PCT No.: PCT/GB2008/050638

§ 371 Date: Mar. 25, 2010

(30) Foreign Application Priority Data
Aug. 1, 2007 (GB) 0714939.6

(51) Int. Cl. B08B 7/00

(52) U.S. Cl. 134/1; 134/34

(57) ABSTRACT

A method for removing oil from oil-contaminated material comprising the steps of: a) reducing the particle size of oil-contaminated material using shearing means (112) to form reduced particle size material; b) mixing the reduced particle size material with a solution comprising a surfactant (20), wherein the surfactant (20) absorbs oil from the reduced particle size material; and c) separating the surfactant containing the absorbed oil from the reduced particle size material (34).

### FIELD OF THE INVENTION

This invention relates to a method for removing oil from oil-contaminated waste. In particular, the present invention relates to the removal of oil from drilling wastes such as drill cuttings and oil slops, and other industrial oily wastes such as refinery and interceptor wastes.

### BACKGROUND OF THE INVENTION

Drilling fluids or “muds” are oil- or water-based formulations which are used as lubricants and stabilisers in the drilling of oil and gas wells. Oil-based muds tend to have superior performance and are used in difficult drilling conditions, such as in horizontal drilling.

Drilling mud is pumped down hole to a drill bit and provides lubrication to the drill string and the drilling bit. The mud also prevents or inhibits corrosion and can be used to control the flow of fluid from a producing formation.

Drilling mud returning to surface may carry with it rock cuttings which are commonly known as ‘drill cuttings’. The drill cuttings may be saturated with oil. Depending on the character of the rock formation being drilled, the drill cuttings may comprise, for example, clay, shale, sandstone or limestone. The returning mud with entrained drill cuttings is separated into drilling mud and cutting fractions by passing the returning mud over, for example, shaker screens or other separating equipment. The separated mud may be reused, while the oil-contaminated cutting fractions are stored for subsequent treatment and disposal.

Disposal of oil-contaminated drill cuttings is a major problem in the oil industry. The drill cuttings may contain up to 25% oil by weight. Although it was previous practice to dispose of untreated cuttings simply by dumping the cuttings adjacent the drill site, for example, onto the seabed, this is environmentally unfriendly and is now illegal in many jurisdictions. There is currently legislation pending, or in place, in many countries which only permits “zero discharge” drilling operations. Dumping of untreated cuttings is therefore becoming prohibited.

Currently, in offshore operations, it is practice to collect and store the oil-contaminated drill cuttings on an offshore drilling unit and thereafter transport the drill cuttings to an onshore location for treatment and cleaning. Alternatively, in some cases the drill cuttings can be slurrified and re-injected into a sub sea formation. However, this again has its own environmental problems.

With thousands of tonnes of drill cuttings being formed in drilling operations worldwide, the transportation costs are significant. For example, currently there are approximately 350 wells that are drilled in the North Sea every year and each produces an average of 800-1,000 tonnes of waste drilled cuttings. Accordingly, it can be estimated that 280,000-300,000 tonnes of waste drilled cuttings are produced each year and around 50,000 tonnes of drill cuttings are brought onshore each year for treatment.

The contaminated drill cuttings are treated onshore using conventional means to remove as much oil as possible and thereafter are, for example, sent for landfill. The treated cuttings may also be utilised as road building material, low grade building products or as fertiliser filler.

The storing of oil-contaminated drill cuttings and well bore clean-up fluids on a drilling platform is a major problem due to limited storage space. For example, a single drilling operation may produce up to 800 tonnes of drilling waste and 100 tonnes of pit and well-bore clean-up fluid which is typically stored in 5 tonne capacity containers or skips and thereafter transferred offshore. Many containers or skips are therefore required which takes up valuable deck space. Furthermore, if bad weather prevents transport vessels from emptying the full containers or skips, drilling operations may have to be suspended until the weather improves and the material can be transported.

The current practice of storing oil-contaminated drill cuttings in containers or skips on the oil platform also leads to health and safety issues. For example, the loading of containers or skips onto a transport vessel is usually done by crane. This is a slow process and requires many crane movements (up to 1,000 additional movements for every well), thereby increasing the risk of accidents occurring.

An alternative approach to storing the oil-contaminated drill cuttings in containers or skips is to slurify the drill cuttings and store them on or below the deck of the drilling platform or vessel. The macerated cuttings are subsequently pumped onto a transport vessel. However, such slurified cuttings are generally too fine to be handled easily in conventional onshore drill cutting processing facilities. Furthermore, while the macerated drill cuttings are stored on the platform, the drill cuttings must be maintained in circulation to avoid settling-out of the cuttings; any settling of the cuttings would prevent pumping onto a transport vessel. Such a process also has the disadvantage of increasing the volume of the waste.

Consequently, all of the known approaches to safely disposing of oil-contaminated drill cuttings are heavily dependent on weather conditions to permit transport vessels to approach the offshore facility and offload the oil-contaminated material such as drill cuttings. In some areas, for example, the eastern Atlantic Ocean to the west of the Shetland Isles, it has been estimated that in winter some 65% of drilling costs are weather related. Reduction of the reliance on favourable weather conditions would therefore be of considerable benefit.

Similarly, in other industries such as refining and waste management, there are large quantities of oily solids, such as interceptor sludges and the like that require disposal. Landfill is no longer an alternative for liquid wastes, due to new landfill legislation, and as a result these substances require treatment to provide recyclable/inert materials than can be disposed of in an environmentally safe manner. Current methods require transportation and typically treatment by thermal desorption, incineration or mixing with inert materials (such as with fly ash) and landfill. New legislation is also prohibiting the mixing of hot waste material with fly ash. This is expensive from both a financial and an environmental aspect.

Techniques such as described in WO 99/05392, WO 00/54868, WO 02/20473, and GB 2347682B, are known to remove oil from oil-contaminated wastes such as drill cuttings. The material obtained using these processes may not have a low enough oil content to be disposed of overboard on an oil platform and may have to undergo a series of treatment cycles or more than likely still require transportation to an onshore treatment facility. In addition, the sample sizes used in these patents is only about 60 g and is therefore not a realistic measure for treating large scale volumes.

A further significant problem is the actual percentage of oil content discussed in the prior art such as in GB 2347682B. In GB 2347682B a retort method is used to obtain the oil content values. Retort methods are inherently inaccurate and produce an error of at least plus/minus 2.5% in measured oil content. Furthermore, in GB 2347682B the initial oil content is 7% which is a low initial value to start off with. For example, cuttings coming off a shaker screen usually have about 15-22% oil content. The shale cuttings in GB 2347682B would therefore appear to have undergone some initial treatment or natural evaporation prior to adding a surfactant. It is therefore extremely unlikely that the process in GB 2347682B could cope with cuttings containing 15-22% oil content. Additionally, in GB 2347682B a polycarbonate centrifuge bottle is used which may further distort the results as the polycarbonate will potentially absorb some oil.

The method disclosed in GB 2347682B is therefore highly unlikely to produce repeatable results when treating drill cuttings or oil slops to provide resulting solid material which has an oil content of less than 1%. The oil content must also be measured using accurate measurement devices such as Gas Chromatography (GC) or Fourier Transform Infrared Spectroscopy (FTIR) otherwise anomalous results are obtained.

It is also common to use technology such as described in WO 2005/023430, which is incorporated herein by reference. However, the use of technology can be expensive with specific formulations required to be manufactured for each different type of process.

It is amongst the objects of the present invention to obviate or mitigate at least one of the aforementioned problems.

It is a further object of the present invention to provide a method of removing oil from oil-contaminated wastes.

It is a yet further object of a preferred embodiment of the present invention to remove oil from oil-contaminated drilling waste such as drill cuttings to a level below 1% so that the treated drill cuttings may be disposed of overboard from an offshore drilling platform or vessel.

### SUMMARY OF THE INVENTION

According to a first aspect of the present invention there is provided a method for removing oil from oil-contaminated material comprising the steps of:
a) reducing the particle size of oil-contaminated material using shearing means to form reduced particle size material;
b) mixing the reduced particle size material with a solution comprising a surfactant, wherein the surfactant absorbs oil from the reduced particle size material; and
c) separating the surfactant containing the absorbed oil from the reduced particle size material.

The oil-contaminated material may, for example, be any drilling waste such as drill cuttings or oil slops formed during drilling for oil or gas. The drill cuttings may be saturated with oil and may comprise up to 25% oil by weight. Alternatively, the oil-contaminated material may, for example, be oil-contaminated material formed in refineries or during waste management such as interceptor sludges.

The present invention specifically uses non-microemulsion forming surfactants. The non-microemulsion forming surfactant may be selected from any suitable cationic, anionic or non-ionic surfactants commercially available. Biosurfactants may also be used.

The surface tension at plain oil-water interfaces is typically of the order of 50 mNm⁻¹. Mixtures, according to the present invention, formed by mixing oil, water and non-microemulsion forming surfactants are typically characterised by interfacial surface tensions of the order of about 20-50 mNm⁻¹, whereas microemulsions are characterised by far lower surface tensions of ultra-low interfacial surface tensions, typically below 20 mNm⁻¹, and can be in the order of 10⁻³ to 10⁻⁶ mNm⁻¹; these latter values reflecting the absence of direct oil-water contact at the interface.

Surfactants are generally known as wetting agents that lower the surface tension of a liquid, allowing easier spreading, and lower the interfacial tension between two liquids. In the present invention, the non-microemulsion forming surfactant supplies a detergent action to the oil-contaminated material, with the result of removing the oil from the contaminated material.

A surfactant can be classified by the presence of formally charged groups in its head. A non-ionic surfactant has no charge groups in its head. The head of an ionic surfactant carries a net charge. If the charge is negative, the surfactant is more specifically called anionic. If the charge is positive, it is called cationic. If a surfactant contains a head with two oppositely charged groups, it is termed as zwitterionic.

Suitable ionic non-microemulsion forming surfactants according to the present invention may be selected from any one of or combination of the following:
(a) Anionic (e.g. based on sulfate, sulfonate or carboxylate anions)
   Sodium dodecyl sulfate (SDS), ammonium lauryl sulfate, and other alkyl sulfate salts
   Sodium laureth sulfate, also known as sodium lauryl ether sulfate (SLES)
   Soaps, or fatty acid salts
(b) Cationic (e.g. based on quaternary ammonium cations)
   Cetyl trimethylammonium bromide (CTAB) which is commonly known as hexadecyl trimethyl ammonium bromide, and other alkyltrimethylammonium salts
   Cetylpyridinium chloride (CPC)
   Polyethoxylated tallow amine (POEA)
   Benzalkonium chloride (BAC)
   Benzethonium chloride (BZT)
(c) Zwitterionic (amphoteric)
   Dodecyl betaine
   Dodecyl dimethylamine oxide
   Cocamidopropyl betaine
   Coco ampho glycinate

Suitable non-ionic surfactants according to the present invention may be selected from any one of or combination of the following:
Alkyl poly(ethylene oxide)
Copolymers of poly(ethylene oxide) and poly(propylene oxide) (commercially called Poloxamers or Poloxamines)
Alkyl polyglucosides, including:
   Octyl glucoside
   Decyl maltoside
Fatty alcohols
   Cetyl alcohol
   Oletyl alcohol
Cocamide MEA, cocamide DEA, cocamide TEA

The surfactants according to the present invention may be dissolved in any suitable solvent. For example, any appropriate organic or inorganic solvent may be used. In particular embodiments, alcohol solvent systems may be used. Typically, the alcohol may be an aliphatic alcohol ranging from C1-C30 or more preferably C2-C6. For example, the alcohol may be methanol, ethanol, propanol, butanol or any combination thereof. Moreover, the solvent system may also comprise a combination of other solvents such as any appropriate glycol ether systems.

In particular embodiments, any one of or combination of the following surfactant systems may be used: Well Cleaner RX-03; Well Cleaner RX-8040; Well Cleaner RX-8042; Well Cleaner RX-8045; Well Cleaner RX-8046; Well Cleaner RX-8056; Well Cleaner RX-8056E; and Well Cleaner RX-09BD. All of these compounds may be obtained from Roemex Limited of Badentoy Crescent, Badentoy Park, Portlethem, Aberdeen, AB12 4YD.

The compositions of each of these compositions are described in more detail below:

Well Cleaner RX-03

| Composition | Weight (%) |
|---|---|
| Aliphatic Alcohol | >70 |
| Glycol Ether | <5 |
| Nonionic Surfactant | <25 |

Well Cleaner RX-8040

| Composition | Weight (%) |
|---|---|
| Glycol ether | 40-55 |
| Aliphatic Alcohol | 5-15 |
| Nonionic Surfactant | 5-15 |

Well Cleaner RX-8042

| Composition | Weight (%) |
|---|---|
| Distillates (petroleum) Hydrotreated | 60-100 |
| Light Oil | |

Well Cleaner RX-8045

| Composition | Weight (%) |
|---|---|
| Distillates (petroleum) Hydrotreated | 60-100 |
| Light Oil | |

Well Cleaner RX-8046

| Composition | Weight (%) |
|---|---|
| Distillates (petroleum) Hydrotreated | 60-100 |
| Light Oil | |
| Nonionic Surfactant | <10 |
| Aliphatic Alcohol | <10 |
| Butyl Diglycol | <10 |

Well Cleaner RX-8056

| Composition | Weight (%) |
|---|---|
| Glycol Solvent | 20-30 |
| Non-ionic Surfactant | 15-20 |

Well Cleaner RX-8056E

| Composition | Weight (%) |
|---|---|
| Glycol Solvent | 20-30 |
| Non-ionic Surfactant | 15-20 |
| Aliphatic Alcohol | 5-10 |

Well Cleaner RX-09BD

| Composition | Weight (%) |
|---|---|
| Aliphatic Alcohol | <80 |
| Anionic Surfactant | <10 |
| Glycol Solvent | <35 |

The reduced particle size material after treatment with the surfactant may have less than 1% oil by weight, less than 0.75% oil by weight, less than 0.5% oil by weight, less than 0.25% oil by weight and preferably less than 0.1% oil by weight. The term oil herein is taken to mean any hydrocarbon compound.

Typically, the oil-contaminated material may have an average particle size of less than 1000×10⁻⁶ m (1000 microns), less than 500×10⁻⁶ m (500 microns) or preferably less than 100×10⁻⁶ m (100 microns), less than 10×10⁻⁶ m (10 microns) or less than 1×10⁻⁶ m (1 micron). The particles may also have a range of 0 to 1000×10⁻⁶ m (0 to 1000 microns), 0 to 500×10⁻⁶ m (0 to 500 microns), 0 to 200×10⁻⁶ m (0 to 200 microns) or 0 to 50×10⁻⁶ m (0 to 50 microns). It has been found that it is preferred to reduce the particles down to less than 130×10⁻⁶ m (130 microns).

The particles may be reduced in size by any type of shearing means. By shearing is meant that the particles are cut and/or sliced open thereby reducing the particle sizes and increasing the available surface area. At least one angular cut may therefore be made through the particles. The shearing means may, for example, be rotatable cutting blades. The cutting blades may be rotated at high speeds of up to 1000-6000 rpm. The shearing process may last for about, for example, 2-30 minutes or preferably about 5-10 minutes.

The shearing means may comprise a plurality of impellors mounted on a single drive shaft. Preferably, there may be two impellors. Typically, the impellors may comprise a series of blades. Conveniently, the pitch of the blades in the impellors may be opposite or at least different so that the blades cause the particles to impact and collide with each other. By causing the particles to impact against each other, leads to a high shearing effect that reduces the particle sizes and increases the surface area of the particles. As the particles shear themselves, rather than the actual blades, this reduces wear and tear on the impellor blades. In this embodiment, the impellors may rotate at a reduced speed of 300-2000 rpm. The impellors may be separated by any suitable distance. Preferably, the impellors may be separated by a distance of about half the diameter of the rotating impellors such as, for example, 0.2 m to 0.5 m.

An alternative shearing means may comprise a rotor which may be enclosed within a casing such as, for example, a substantially cylindrical casing. The oil-contaminated material may initially be drawn in through an opening in the casing on rotation of the rotor. On rotation of the rotor, the particles may be forced via centrifugal force to the outer regions of the casing where the particles may be subjected to a shearing action.

The particles may shear against each other. The shearing action may occur in a precision machined clearance of 100×10⁻⁶ to 1000×10⁻⁶ m (100 to 1000 microns) or preferably 50×10⁻⁶ to 200×10⁻⁶ m (50 to 200 microns) between the ends of the rotor and the inner wall of the casing. The milled particles will then undergo an intense hydraulic shear by being forced, at high velocity, out through perforations in the outer wall of the casing. During this process, fresh material may be drawn into the casing. During this process, fresh material may be drawing into the casing. Using this process, the particles may be reduced down to a size of 0 to 500×10⁻⁶ m (0 to 500 microns) or preferably 0 to 180×10⁻⁶ m (0 to 180 microns). By reducing the particle sizes, the surface area of the oil-contaminated material is increased which facilitates the ability of the surfactant to remove oil deposits entrapped in the oil-contaminated material. To aid the shearing process, water may be added to the oil-contaminated material which, in effect, turns the material into a slurry.

In a yet further alternative, an ultrasonic process using high frequency electromagnetic waves may be used to reduce the particle sizes; the particles disintegrate on exposure to the high frequency electromagnetic waves.

A further alternative to shear the particles may be to use a fluidic mixer such as an air driven diffuser mixer which uses compressed air to suck the particles through a mixer. A suitable fluidic mixer is manufactured by Stem Drive Limited and is described, for example, in WO 00/71235, GB 2313410 and GB 2242370. In WO 00/71235, a fluidic mixing system is described wherein at least one pneumatic mixer may be arranged to eject gas at an angle to the vertical to thereby entrain a flow of fluid material within a tank to cause mixing and a reduction in particle sizes of a fluid material. WO 00/71235 also describes a fluid powered mixer wherein gas from a gas supply is ejected from a perforated annulus and the forward flowing gas pulls material from the rear of the mixer. Mixed material of reduced particle size may then be forcibly ejected from the mixer.

Another alternative to shear the particles is to use a cavitation high shear mixer wherein a vortex is used to create greater turbulence to facilitate the reduction in particle sizes. Such a device is made by Greaves Limited and is described as the Greaves GM Range (Trade Mark). The Greaves GM Range (Trade Mark) of mixers uses fixed vertical baffles to create extra turbulence when, for example, a deflector plate is lowered.

A further alternative to shear the particles is to use a hydrocyclone apparatus or any other suitable centrifugation system.

The shearing method may comprise any combination of the above-described methods.

Prior to the addition of any surfactant, an electric current may be passed through the oil-contaminated material. This does not affect the particle size but merely helps to separate out the oil. It has been found that by using a burst cell electro-chemical system and by customising the wave shape, frequency and pulse, the oil-contaminated material may be separated into, for example, 3 phases: an oil phase, a water phase and a solid phase. A centrifugation process may be used to separate the different phases. Alternatively, material may be left overnight for the separation to occur. This process reduces the amount of oil in the solids thereby reducing the amount of oil which needs to be removed by the surfactant. This may reduce the amount of surfactant which may be required to remove the oil. This is advantageous as the surfactant is expensive.

To remove oil deposits from the oil-contaminated material, the surfactant may be added to the oil-contaminated material during the step of reducing the particle sizes. Typically, the surfactant may be capable of spontaneously absorbing oil.

The obtained solid material may be tested to ensure that the amount of oil has been reduced to an acceptable level such as below 1% oil by weight, below 0.5% oil by weight or preferably below 0.1% oil by weight. If the oil level is too high, the material may be retreated.

Solid material which has less than 1% oil by weight may be discarded overboard from an oil platform or vessel onto the seabed. The solid material is measured as a dry material i.e. not wet.

Conveniently, the oil in the oil-in-water may be recovered by temperature-induced phase separation using well-known procedures.

According to a second aspect of the present invention there is provided apparatus for removing oil from oil-contaminated material comprising:
a) shearing means for reducing the particle size of oil-contaminated material;
b) means for mixing the reduced particle size material with a solution of a surfactant, wherein the surfactant absorbs oil from the reduced particle size material; and
c) means for separating the surfactant containing the absorbed oil and the reduced particle size material.

The apparatus may be portable and adapted to be situated on, for example, an oil or gas drilling platform or vessel. The apparatus may be self-contained or containerised.

The shearing means may comprise rotatable cutting blades. The cutting blades may be rotated at high speeds of up to 1000-6000 rpm. The cutting blades shear the particles of the oil-contaminated material.

Typically, the shearing means may comprise a plurality of impellors mounted on a single drive shaft. The impellors may comprise a series of blades. Conveniently, the pitch of the blades in each of the impellors may be substantially opposite or at least substantially different so that the impellors may cause the particles to impact onto each other. By causing the particles to impact against each other, leads to a shearing effect which reduces the particle sizes and increases the surface area of the particles. The impellers may rotate at a speed of 300-2000 rpm. The impellors may be separated by any suitable distance. Preferably, the impellors may be separated by a distance of about half the diameter of the rotating impellors such as, for example, 0.2 to 0.5 m.

In an alternative, the shearing means may comprise a rotor which may be enclosed within a casing such as substantially cylindrical casing. The oil-contaminated material may initially be sucked in through an opening in the casing on rotation of the rotor. On rotation of the rotor, the particles maybe forced via a centrifugal to the outer regions of the casing where they may be subjected to a milling action. The milling action may occur in a precision machined clearance of 50×10⁻⁶ to 500×10⁻⁶ m (50 to 500 microns) or preferably 70×10⁻⁶ to 180×10⁻⁶ m (70 to 180 microns) between the ends of the rotor and the inner wall of the casing. The milled particles will then undergo an intense hydraulic shear by being forced, at high velocity, out through perforations in the outer wall of the casing. During this process, fresh material may be drawn into the casing. Using this process, the particles may be reduced down to a size of 0 to 500×10⁻⁶ m (0 to 500 microns) or preferably 0 to 180×10⁻⁶ m (0 to 180 microns).

In a further alternative, the shearing means may comprise ultrasonic means.

In yet a further alternative, a fluidic mixer or a cavitation high shear mixer may be used to reduce the particle sizes.

Alternatively any combination of the above methods may be used to reduce the particle sizes.

Any means suitable for mixing the oil-contaminated material and the surfactant may be used. For example, cutting blades on rotation may cause mixing to occur or a separate stirrer may be incorporated into the apparatus. The apparatus may also be agitated by, for example, shaking or inverting to mix the different components.

Typically, a filtration and/or centrifugation unit may be used to separate the surfactant containing the absorbed oil from the treated reduced particle size particles. However, any other suitable separating means may be used. In a further alternative, a combination of shakers and hydrocyclones may be used such as the ES1400 microfluidic system manufactured by Triflow Industries.

The apparatus may comprise a series of rinsing areas, for example tanks, wherein the treated reduced particle size material may be rinsed with, for example, water or salt water to remove any retained surfactant and oil. The reduced particle size material may be separated using a filter or a centrifugation unit.

The apparatus may also comprise a fluid treatment system which treats the fluid removed form the system which will be contaminated with oil. The fluid treatment system may comprise a plurality of adsorbing cartridges which adsorb oil. This process may be continued until the water has less than 40 ppm total hydrocarbon content and may be discharged safely into the sea. The oil adsorbing cartridges may be made from any suitable oil adsorbing material such as polycarbonate. Alternatively, oil absorbing cartridges may be used.

### BRIEF DESCRIPTION OF THE DRAWINGS

Embodiments of the present invention will now be described, by way of example only, with reference to the accompanying drawings in which:

FIG. 1 is a flow chart representing steps in a method of removing oil from drill cuttings according to an embodiment of the present invention;

FIG. 2 is a schematic representation of apparatus used to reduce the particle sizes of drill cuttings according to a further embodiment of the present invention;

FIG. 3 is a schematic representation of apparatus used to reduce the particle sizes of drill cuttings according to a yet further embodiment of the present invention;

FIGS. 4a and 4b represent a blending impellor and a shear rotor according to further embodiments of the present invention;

FIGS. 5a-5c are schematic representations of apparatus used to reduce the particle sizes of drill cuttings according to a further embodiment of the present invention;

FIG. 6 is a schematic representation of apparatus used to reduce the particle sizes of oil contaminated material and remove the oil from the material according to a yet further embodiment of the present invention;

FIG. 7 is a side view of the apparatus shown in FIG. 6;

FIG. 8 is a top view of the apparatus shown in FIGS. 6 and 7;

FIG. 9 is an end view of the apparatus shown in FIGS. 6-8;

FIG. 10 is a side view of a water treatment system according to a further embodiment of the present invention;

FIG. 11 is a top view of the water treatment system shown in FIG. 10;

FIG. 12 is a part sectional view of part of the water treatment system shown in FIGS. 10 and 11;

FIGS. 13 and 14 are flow charts representing steps in a method of removing oil from raw slops according to an embodiment of the present invention; and

FIGS. 15 and 16 are flow charts representing steps in a method of removing oil from drill cuttings according to an embodiment of the present invention.

### DETAILED DESCRIPTION

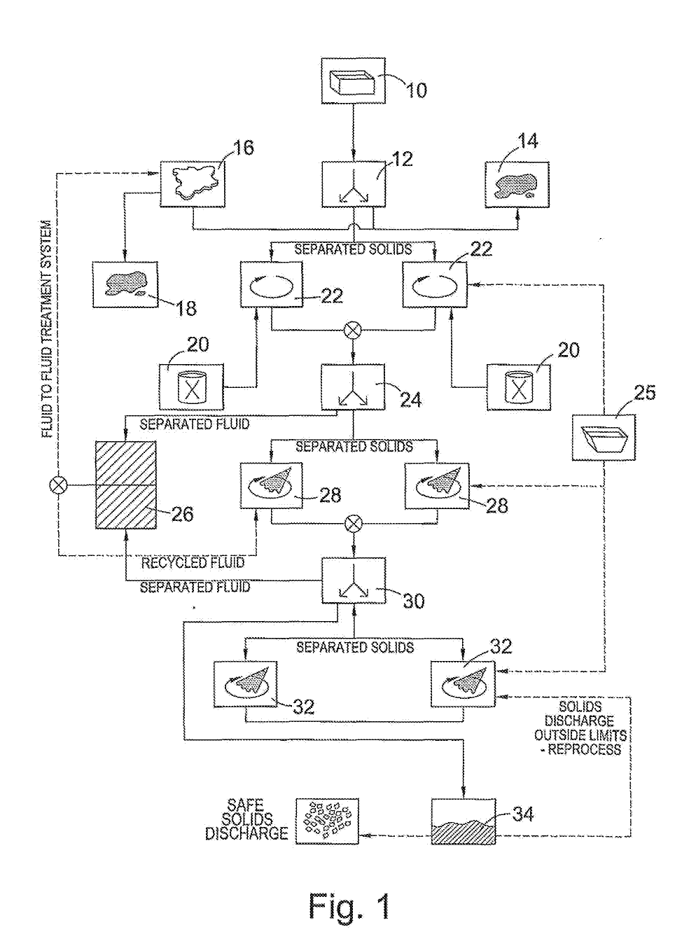

FIG. 1 is a flow chart of steps in a process of removing oil from solids such as drill cuttings. Although the following description relates to the treating of oil-contaminated drill cuttings, any other oil-contaminated solid material may be treated in a similar way.

Drilling mud which is circulated downhole becomes mixed with drill cuttings. The resulting mixture, identified by the reference numeral 10 in FIG. 1, comprises drilling mud and oil-contaminated drill cuttings.

The mixture 10 is initially passed through a separator 12 which separates the mixture 10 into drilling mud and separated solids. The drilling mud is recycled to the drilling system.

The separated drill cuttings are then mixed with a surfactant 20 (i.e. a ‘mixing agent’) in a mixing apparatus 22. The surfactant 20 used in the present invention is a non-microemulsion surfactant which provides a detergent action. Water or salt water is added from a water tank 25 to form a slurry. As shown in FIG. 1, there is a number of mixing apparatus 22.

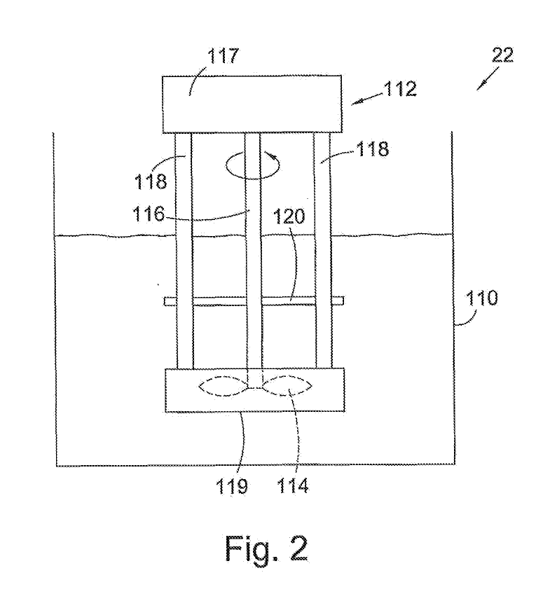

FIG. 2 is a schematic representation of possible mixing apparatus 22. The mixing apparatus 22 comprises a container 110 and a cavitation mixer, generally designated 112, comprising rotatable blades 114 on a drive shaft 116. The rotatable blades 114 are enclosed in a casing 119 which has a plurality of apertures (not shown). The cavitation mixer 112 also comprises a series of baffles 118 and a deflector plate 120. The baffles 118, deflector plate 120 and plurality of apertures in the casing 119 serve to increase turbulence during stirring and improves the shearing process. The height of the deflector plate 120 may be adjusted to maximise the cavitation. The drive shaft 116 is connected to a motor 117 and rotates at about 1000-6000 rpm for about 5-10 minutes.

The cavitation mixer 112 shears the drill cuttings and reduces the particle sizes of the drill cuttings. Shearing the drill cuttings has the advantageous effect of increasing the surface area of the drill cuttings. The particles are reduced in size from 0 to 1000×10⁻⁶ m (0 to 1000 microns) to 0 to 100×10⁻⁶ m (0 to 100 microns). Increasing the surface area facilitates the access of the surfactant to oil deposits entrapped within the drill cuttings.

The surfactants used are capable of spontaneously absorbing oil.

After mixing for about 10 minutes, the resulting mixture is passed to a centrifugation unit 24 which separates the drill cutting particles from the surfactant containing oil and water phase. The centrifugation procedure lasts for about 5-10 minutes and spins at about 2,000 to 3,500 rpm. The separated surfactant and water phases are passed to a fluid storage tank 26.

As shown in FIG. 1, the separated solids are passed to rinsing apparatus 28. Any residual surfactant remaining among the drill cutting particles is thus removed by rinsing with water or salt water. Water from water tank 25 or from fluid treatment cycle 16.

Centrifugation apparatus 30 is used to separate the drill cuttings from the rinsing water now containing any residual surfactant, if required.

A further rinsing step may then take place in rinsing apparatus 32 which removes any remaining surfactant. The mixture is centrifuged again with substantially oil-free solids 34 being removed. Alternatively, substantially oil-free solids may be produced directly from the centrifugation apparatus.

The substantially oil-free solids 34 are then tested for oil contamination. Testing is performed using Gas Chromotography (GC) or Fourier Transform Infrared Spectroscopy (FTIR). If the solids 34 are sufficiently clean, the solids 34 may be discharged over the side of an oil platform or vessel onto the seabed.

If the solids 34 are not clean enough, the solid material can be retreated through the cleaning cycle.

Well bore clean-up fluids may be treated in a similar manner to that of drill cuttings. The well bore clean-up fluid may be used in the form of a viscous pill which is circulated back up the annulus of the well followed by brine. Initially, the high viscous material contained in the returning fluids is pre-treated with another chemical to induce flocculation prior to putting in system.

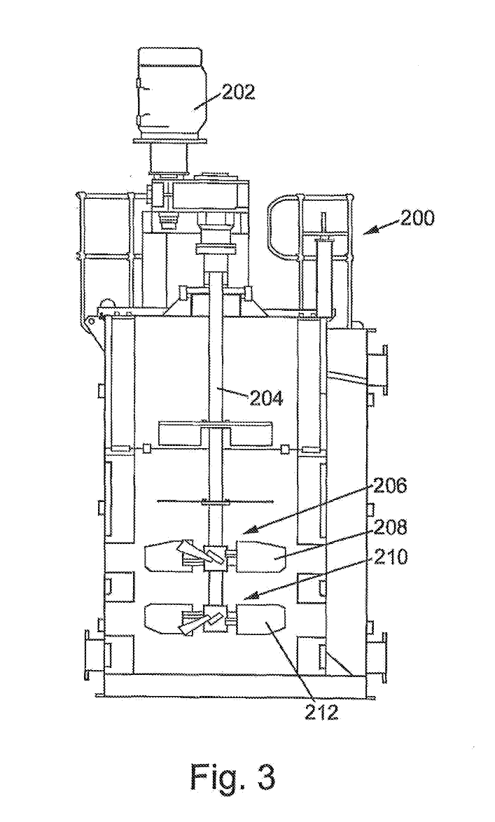

FIG. 3 is a schematic representation of apparatus, generally designated 200, used to shear oil-contaminated particles. The shearing apparatus 200 comprises a motor 202 connected to a drive shaft 204. At the end of the drive shaft 204 there are two rotors 206,210 which are the same. The pitch of the blades 208,212 on the rotors 206,210 is opposite to one another. This means that on rotation of the rotors 206,210 the oil-contaminated particles are thrust against one another in the region between the rotors 206,210. The rotors 206,210 rotate at a speed of about 300-350 rpm and are separated by a distance of about 0.4 m.

In the region between the rotors 206,210 the particles are in a state of flux and collide with each other at high velocity with the result that the particles shear themselves against one another in these collisions. The particles may be reduced down to a size of about 200 microns. This is advantageous as it increases the lifetime of the rotors 206,210 as the particles are actually shearing themselves.

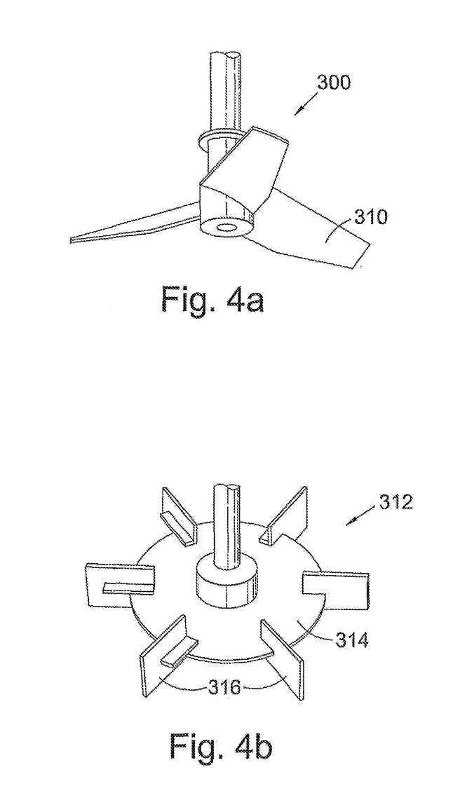

FIGS. 4a and 4b represent a blending impellor 300 and a high shear rotor 312, respectively, which may be used instead of the rotors 206,210 in the apparatus such as that shown in FIG. 3. Impellor 300 is positioned above high shear rotor 312. Impellor 300 merely stirs the oil-contaminated particles whereas the high shear rotor 312 shears the particles.

Impellor 300 has three blades 310 which blend the oil-contaminated particles.

FIG. 4b represents a high shear rotor 312 which is a high shear unit which has six substantially vertically mounted blades 316 on a base plate 314.

On rotation of the impellor 300 and the high shear 312 on a drive shaft in a unit such as that shown in FIG. 3, simultaneous blending and shearing of oil-contaminated particles down to a size of about 200 microns occurs.

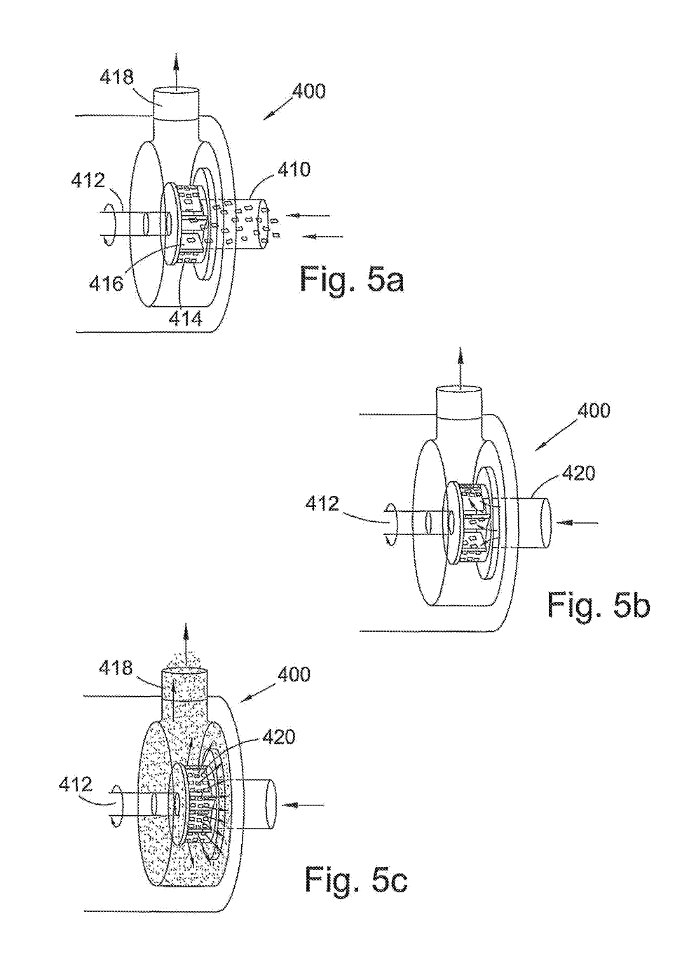

FIGS. 5a-5c represent a further shearing device 400. Shearing device 400 comprises a drive shaft 412 and a rotor 416 mounted on the drive shaft 412. The rotor 416 is encased within a substantially cylindrical casing 414 which is precisely machined so that there is only a small gap of 70×10⁻⁶ to 180×10⁻⁶ m (70 to 180 microns) between the ends of the rotor 416 and the inner surface of the cylindrical casing 414. The cylindrical casing 414 also comprises a series of perforations 420 around its perimeter. The perforations 420 have a size of about 200 microns.

The cylindrical casing 414 has an inlet 410.

On rotation of the drive shaft 412, oil-contaminated material is drawn into inlet 410 and eventually into the substantially cylindrical casing 414. Once the oil-contaminated material is inside the cylindrical casing 414, the oil-contaminated material is driven to the outer parts of the cylindrical casing 414 b centrifugal force. The oil-contaminated material then undergoes a milling action between the small gaps between the end of the rotor 416 and the inner surface of the cylindrical casing 414.

In a further step, the oil-contaminated material then undergoes a hydraulic shear as the oil-contaminated material is forced, at high velocity, out through the perforations 420 and then through outlet 418.

On rotation of the drive shaft 412, fresh oil-contaminated material is continuously fed in through inlet 410 to undergo the shearing process.

Using the system shown in FIGS. 5a-5c, the oil-contaminated material may be reduced down to a size of about 100 microns.

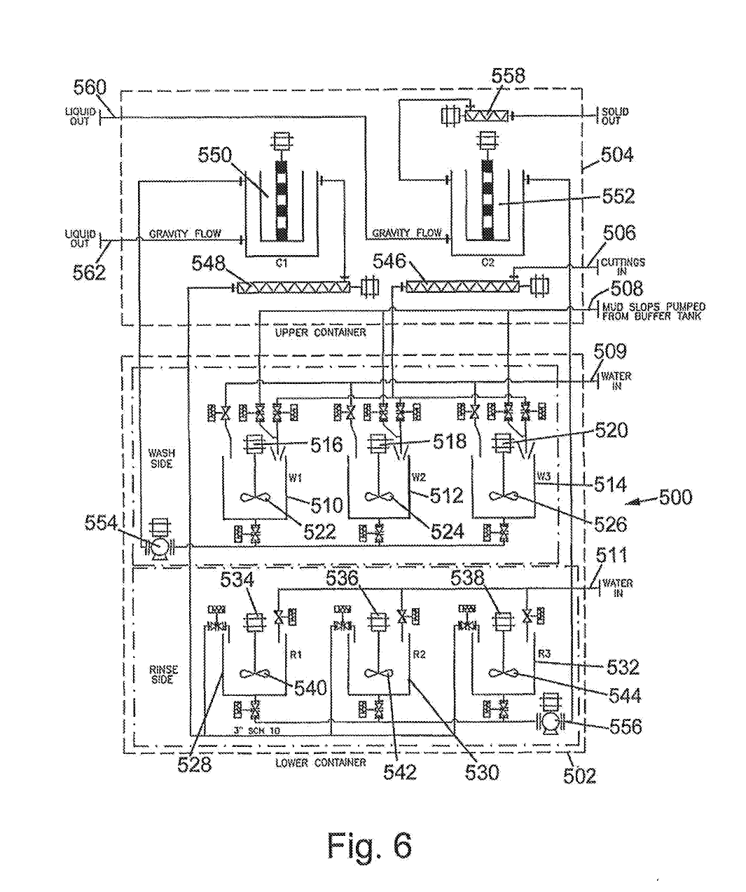

FIG. 6 is a schematic representation of apparatus, generally designated 500, which reduces the particle sizes of oil contaminated material and removes the oil from the contaminated material.

The apparatus 500 comprises a lower container 502 and an upper container 504. The lower container 502 has three wash tanks 510, 512, 514. Each of the wash tanks 510, 512, 514 has a motor 516, 518, 520 connected to a combination of respective shearing blades 522, 524, 526. The shearing blades 522, 524, 526 perform the function of shearing and blending. The lower container 502 also comprises three rinse tanks 528, 530, 532. Each of the rinse tanks 528, 530, 532 comprises a motor 534, 536, 538 connected to respective blending blades 540, 542, 544. Water may enter the wash tanks 510, 512, 514 via pipe 509. Water may enter the rinse tanks 528, 530, 532 via pipe 511. Pumps 554, 556 may be used to circulate the waste material.

In the upper container 504, there are screw conveyors 546, 548 which may be used to move the material. In the upper container 504 there are also two centrifuges 550, 552. There is also an additional screw conveyor 558 in the upper container 504 which may be used to remove cleaned material from the system. Liquid may exit via pipes 560,562.

In use, cuttings may enter the system via pipe 506 or conveyor 546. Slops enter the system via pipe 508. The material entering the system may have up to about 25% or 15-22% oil by weight.

Cuttings entering the system are transferred to the wash tanks 510, 512, 514 using screw conveyor 546.

The first wash tank 510 is initially filled until an appropriate level is reached. Sensors detect once the required level is reached. Mixing is then started. The system then fills wash tank 512. Once wash tank 512 is filled, wash tank 514 is filled. Therefore, as tank 514 is starting to fill, tank 512 is starting to empty and tank 510 is completely empty. A continuous batch process may therefore be set up.

The shearing blades 522, 524, 526 rotate at a speed of 0-400 rpm and are used to shear the particles. The shearing has the effect of reducing the particle sizes down from 0 to 2000×10⁻⁶ m (0-2000 microns) to 0 to 150×10⁻⁶ m (0-150 microns). The surfactant is also added at this stage. The surfactant is initially mixed with seawater. The surfactant is mixed with the seawater to form a 5-15% by weight solution. Sufficient surfactant is added to ensure all of the oil is removed from the material. The material is sheared/blended for 5-10 minutes.

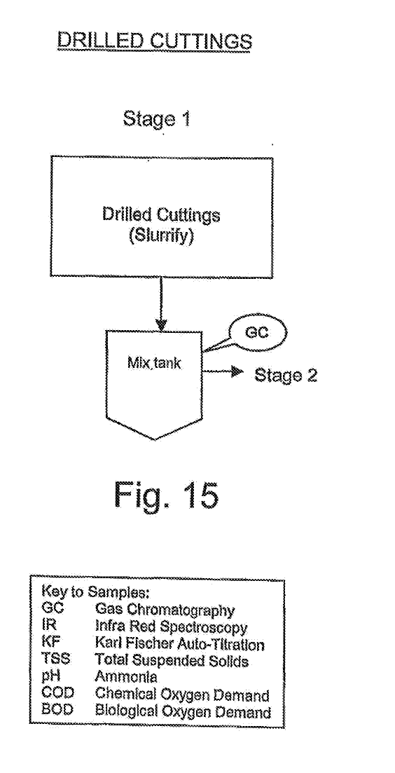

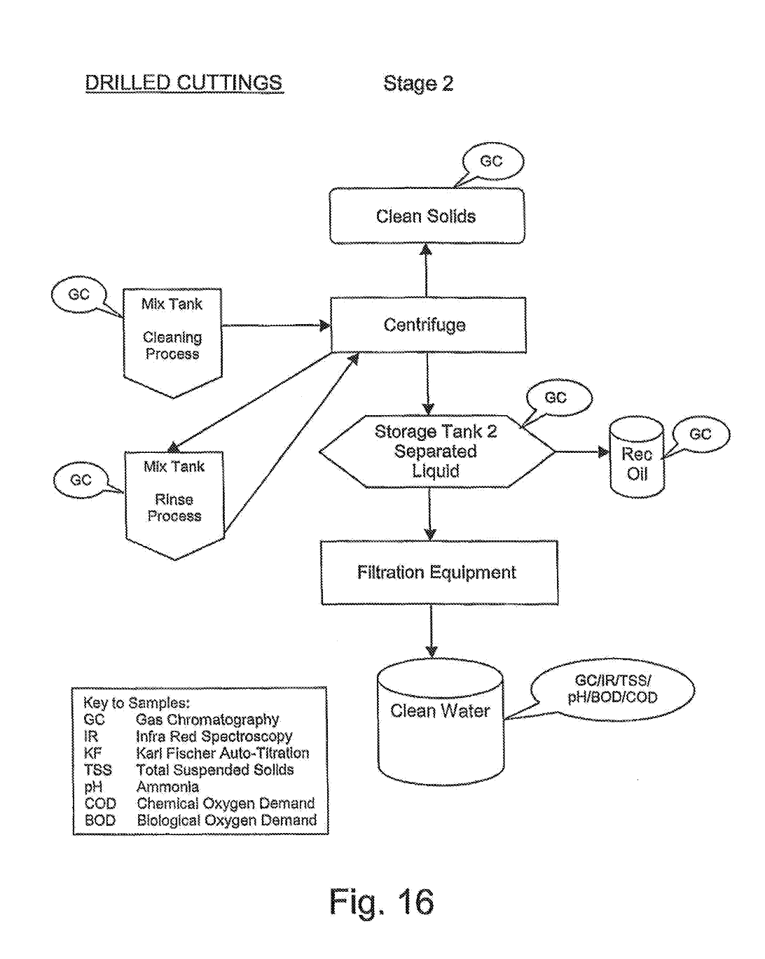

At the end of the shearing/stirring process, resulting slurry is pumped using pump 554 to centrifuge 550 where liquid/solid separation takes place. The resulting liquid is gravity fed to a water treatment system (see FIGS. 13 to 16) where liquid is treated for reuse or discharge as shown by reference numeral 16 and 26 in FIG. 1. Resulting solids are transferred via conveyor 548 to rinse tanks 528, 530, 532, in sequence. Solids at this point may have about 2-5% oil by weight.

Similar to the system for the wash tanks 510, 512, 514, the first rinse tank 528 is filled with seawater until a certain level is reached with the further tanks then being filled in sequence. Therefore, as tank 532 is starting to fill, tank 530 is starting to empty and tank 528 is completely empty. This therefore creates a further continuous batch process.

During the rinsing process, the blades rotate at about 0-400 rpm.

At the end of a period of about 5-10 minutes, resulting slurry is pumped to centrifuge 552 where a further liquid/solid separation takes place. Once again, the resulting liquid is gravity fed to a fluid treatment system, where liquid is treated for reuse or discharge.

The resulting cleaned solids are then transferred via screw conveyor 558 to a holding tank (not shown) for testing and discharge. The resulting solid material has less than 1% oil by weight meaning that the material may be discharged onto the seabed under current regulations.

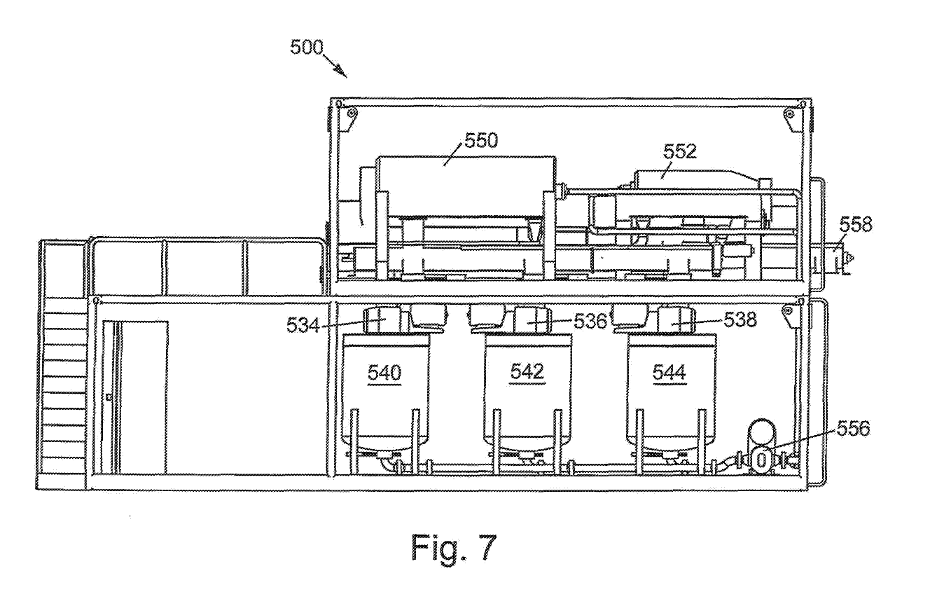

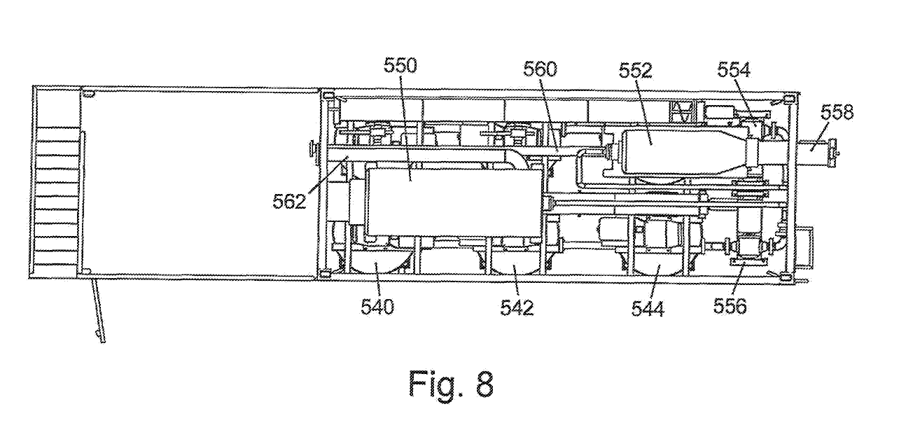

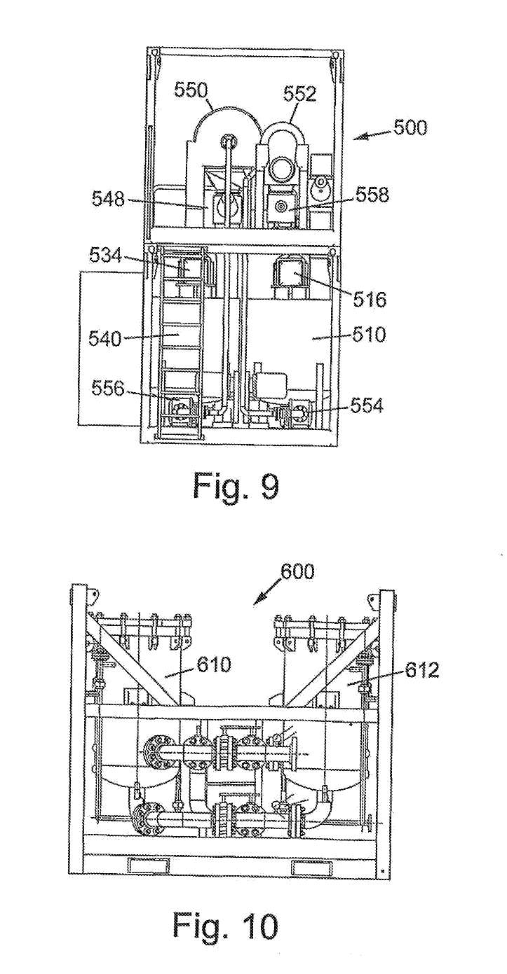

FIGS. 7 to 9 show different views of the apparatus 500 and clearly show the layout of the system. For example, as clearly shown in FIG. 7, the rinse tanks 540, 542, 544 are in a series of tanks along one side with the wash tanks 510, 512, 514 on the other side.

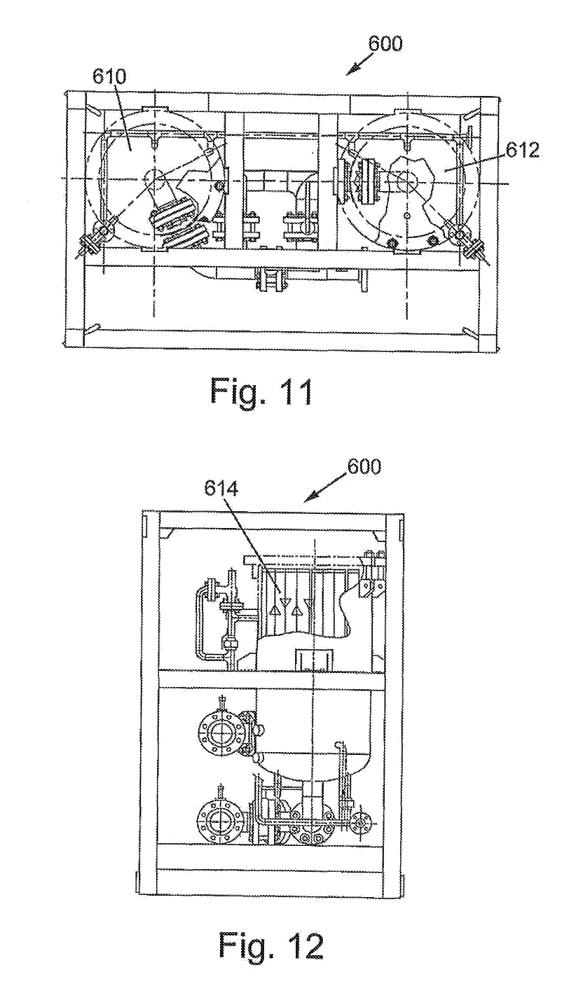

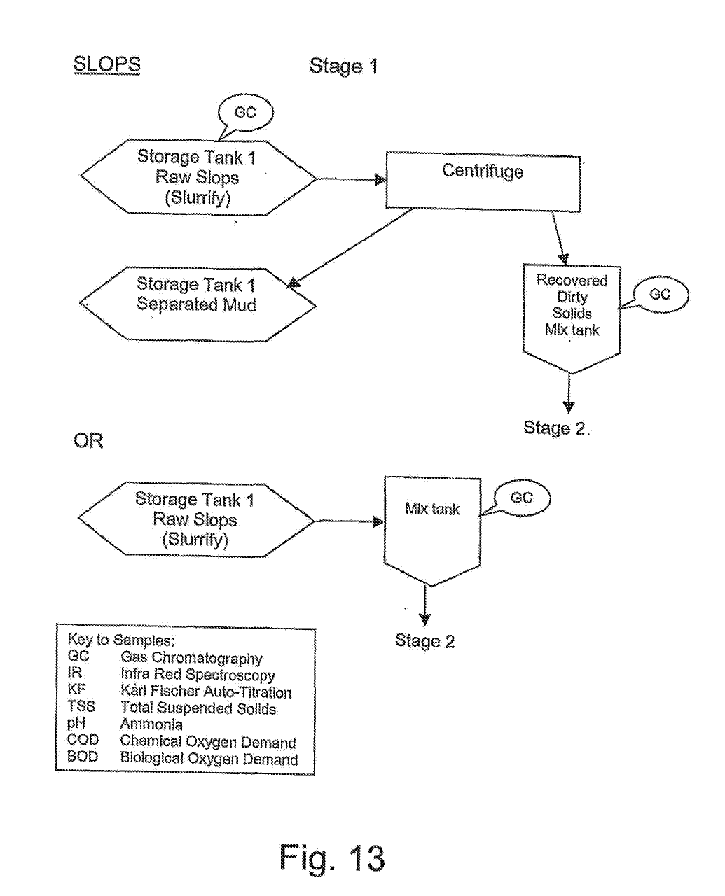

In FIGS. 10-12 there are different views of a water treatment system, generally designated 600. As clearly shown in FIG. 10, the water treatment system 600 comprises two tanks 610, 612.

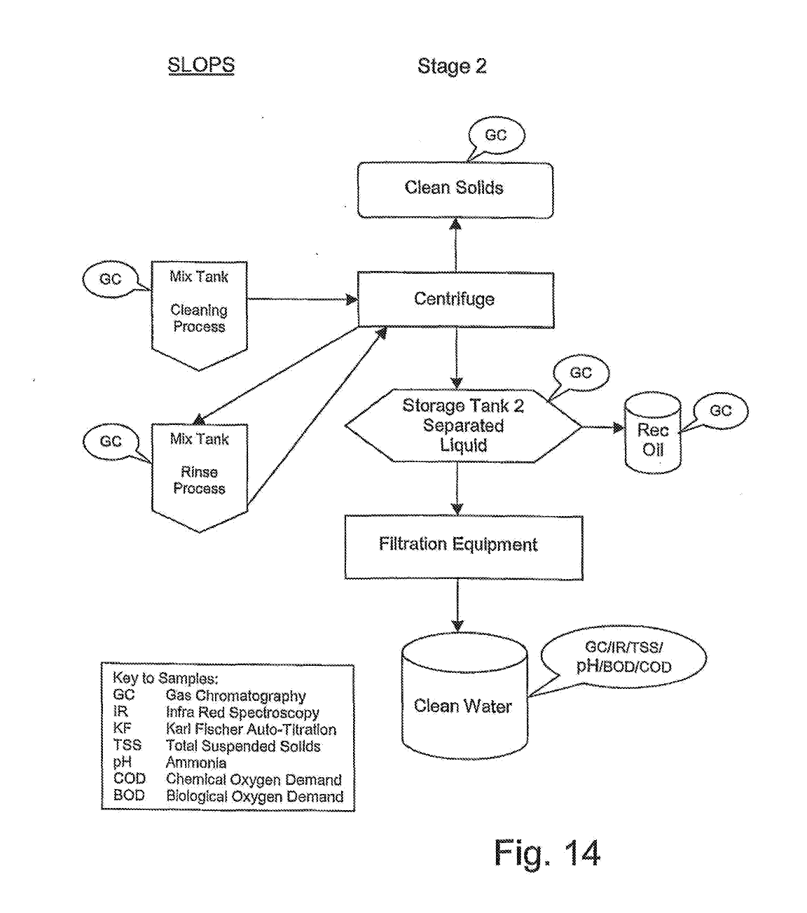

FIG. 12 shows that the tanks comprise vertical oil adsorbing cartridges 614. The oil adsorbing cartridges 614 are made from polypropylene and cellulose. Alternatively, absorbing cartridges may be used.

In use, liquid is fed in from pipes 560, 562, as shown in FIG. 6, into the water treatment system 600.

Although not shown, the liquid may initially be passed through a fine solids removal system such as a hydrocyclone.

Liquid from the apparatus 500 shown in FIG. 6 is therefore fed into the water treatment system 600 wherein the liquid flows through the vertical oil adsorbing cartridges 614. During this process, any residual oil is removed from the liquid.

The tanks 610, 612 comprising the oil adsorbing cartridges 614 may be used in parallel or in tandem, depending on the flow volume throughput.

Clean water will flow from the bottom of the tanks 610, 612. The treated water may be fed to a holding tank and tested prior to discharging.

The water exiting the tanks 610, 612 after treatment has less than 40 ppm total hydrocarbon content in the liquid. Similar to the treated solids which have less than 1% oil by weight, the liquid may be discharged into the sea.

Alternatively, other water treatment processes may be used such as oil absorbent media, CAPS (continuous amorphic porous surface) material, a vortex and coalescing device, and an oxidisation process using UV or ozone or a combination thereof. Oxidation processes using UV ozone are preferable as they do not create additional waste stream.

### EXAMPLES

Bench top laboratory testing using various non-microemulsion forming surfactant/solvent blends of chemical to reduce Total Hydrocarbon Content (THC) and Aromatic Hydrocarbon Content (AHC) on oily solids waste (Drill Cuttings) generated offshore to less than 1% or 10,000 ppm by weight THC and 0.1% or 1,000 ppm by weight AHC.

In the Examples, shearing blades in a bench top mixer were used wherein 400 g of oil-contaminated solids were mixed with 600 g of salt water. The shearing was performed for about 3 minutes with a beach top centrifugation process then performed.

Independent Analysis was carried out using the FTIR Triple Peaks Method.

| | | | | Total | Aromatic |
|---|---|---|---|---|---|
| | | Raw | Dose | Hydrocarbon | Hydrocarbon |
| | | THC | Rate | Content (THC) | Content (AHC) |
| Example | Product | % | % | in ppm | in ppm |
| 1 | Well Cleaner | 4.5 | 2.0 | 6,681 | 444 |
| | RX-03 | | | | |
| 2 | Well Cleaner | 4.5 | 2.0 | 10,710 | 552 |
| | RX-8040 | | | | |
| 3 | Well Cleaner | 4.5 | 2.0 | 10,506 | 599 |
| | RX-8042 | | | | |
| 4 | Well Cleaner | 4.5 | 2.0 | 7,521 | 406 |
| | RX-8045 | | | | |
| 5 | Well Cleaner | 4.5 | 2.0 | 6,225 | 304 |
| | RX-8046 | | | | |
| 6 | Well Cleaner | 4.5 | 2.0 | 7,460 | 367 |
| | RX-8056 | | | | |
| 7 | Well Cleaner | 4.5 | 2.0 | 5,949 | 377 |
| | RX-8056E | | | | |
| 8 | Well Cleaner | 4.5 | 2.0 | 8,570 | 558 |
| | RX-09BD | | | | |

The non-microemulsion forming surfactants used were as follows:

Well Cleaner RX-03

| Composition | Weight (%) |
|---|---|
| Aliphatic Alcohol | >70 |
| Glycol Ether | <5 |
| Nonionic Surfactant | <25 |

Well Cleaner RX-8040

| Composition | Weight (%) |
|---|---|
| Glycol ether | 40-55 |
| Aliphatic Alcohol | 5-15 |
| Nonionic Surfactant | 5-15 |

Well Cleaner RX-8042

| Composition | Weight (%) |
|---|---|
| Distillates (petroleum) Hydrotreated | 60-100 |
| Light Oil | |

Well Cleaner RX-8045

| Composition | Weight (%) |
|---|---|
| Distillates (petroleum) Hydrotreated | 60-100 |
| Light Oil | |

Well Cleaner RX-8046

| Composition | Weight (%) |
|---|---|
| Distillates (petroleum) Hydrotreated | 60-100 |
| Light Oil | |
| Nonionic Surfactant | <10 |
| Aliphatic Alcohol | <10 |
| Butyl Diglycol | <10 |

Well Cleaner RX-8056

| Composition | Weight (%) |
|---|---|
| Glycol Solvent | 20-30 |
| Non-ionic Surfactant | 15-20 |

Well Cleaner RX-8056E

| Composition | Weight (%) |
|---|---|
| Glycol Solvent | 20-30 |
| Non-ionic Surfactant | 15-20 |
| Aliphatic Alcohol | 5-10 |

Well Cleaner RX-09BD

| Composition | Weight (%) |
|---|---|
| Aliphatic Alcohol | <80 |
| Anionic Surfactant | <10 |
| Glycol Solvent | <35 |

Referring to Example, Well Cleaner RX-03 is used which has a concentration greater than about 70 wt. % aliphatic alcohol, less than about 5% glycol ether and less than about 25 wt. % non-ionic surfactant. Using a dose rate of about 2% the total hydrocarbon content (THC) was reduced to 6,681 ppm with an aromatic hydrocarbon content (AHC) of 444 ppm.

The remaining Examples of RX-8040, RX-8042, RX-8045, RX-8046, RX-8056, RX-8056E and RX-809BD all show significant reduction in total hydrocarbon content and aromatic hydrocarbon content.

All of Examples 1-8 therefore reduce the oil content to less than 1% thereby allowing treated drill cuttings to be disposed overboard from an oil platform.

1. A method for removing oil from oil-contaminated material comprising the steps of:
a) reducing the particle size of oil-contaminated material using shearing means to form reduced particle size material;
b) mixing the reduced particle size material with a solution comprising a surfactant, wherein the surfactant absorbs oil from the reduced particle size material; and
c) separating the surfactant containing the absorbed oil from the reduced particle size material.

2. A method according to claim 1, wherein the oil-contaminated material is drilling waste including that of drill cuttings or oil slops formed during drilling for oil or gas.

3. A method according to claim 1, wherein the drill cuttings comprise up to 25% oil by weight.

4. A method according to claim 1, wherein the oil-contaminated material is formed in refineries or during waste management such as interceptor sludges.

5. A method according to claim 1, which uses non-microemulsion forming surfactants.

6. A method according to claim 5, wherein the non-microemulsion forming surfactant is selected from a cationic, anionic or non-ionic surfactant; or biosurfactants.

7. A method according to claim 1, wherein by mixing oil, water and non-microemulsion forming surfactant forms a mixture having interfacial surface tensions of the order of about 20-50 mmNm⁻¹.

8. A method according to claim 1, which uses ionic non-microemulsion forming surfactants selected from any one of or combination of the following:
(a) Anionic surfactants selected from the group consisting of Sodium dodecyl sulphate (SDS), ammonium lauryl sulphate, other alkyl sulphate salts, Sodium laureth sulphate, also known as sodium lauryl ether sulphate (SLES), Soaps, and fatty acid salts,
(b) Cationic surfactants selected from the group consisting of
Cetyl trimethylammonium bromide (CTAB) which is commonly known as hexadecyl trimethyol ammonium bromide, other alkyltrimethylammonium salts,
Cetylpyridinium chloride (CPC),
Polyethoxylated tallow amine (POEA),
Benzalkonium chloride (BAC),
Benzethonium chloride (BZT), and
(c) Zwitterionic (amphoteric) surfactants selected from the group consisting of
Dodecyl betaine,
Dodecyl dimethylamine oxide, and
Coco ampho glycinate.

9. A method according to claim 1 which uses non-ionic surfactants according to any one of or combination of the following:
a) Alkyl poly(ethylene oxide),
b) Copolymers of poly(ethylene oxide) and polypropylene oxide) (commercially called Poloxamers or Poloxamines),
c) Alkyl polyglucosides selected from the group consisting of
Octyl glucoside,
Decyl maltoside,
Fatty alcohols,
Cetyl alcohol,
Oletyl alcohol,
Cocamide MEA, cocamide DEA, and cocamide TEA.

10. A method according to claim 1, wherein surfactants used are dissolved in an organic or inorganic solvent, wherein the solvent is methanol, ethanol, propanol, butanol or any combination thereof.

11. (canceled)

12. A method according to claim 1, wherein the reduced particle size material after treatment with the surfactant has less than 1% oil by weight, less than 0.75% oil by weight, less than 0.5% oil by weight, less than 0.25% oil by weight or less than 0.1% oil by weight.

13. A method according to claim 1, wherein the oil-contaminated material has an average particle size of less than 1000×10⁻⁶ m (1000 microns), less than 500×10⁻⁶ m (500 microns) or preferably less than 100×10⁻⁶ m (100 microns), less than 10×10⁻⁶ m (10 microns) or less than 1×10⁻⁶ m (1 micron).

14. A method according to claim 1, wherein the particles are reduced in size by rotatable cutting blades operating at 1000-6000 rpm.

15. A method according to claim 1, wherein the particles are reduced in size by a plurality of impellors mounted on a single drive shaft rotating at a speed of 300-2000 rpm.

16. A method according to claim 1, wherein an ultrasonic process using high frequency electromagnetic waves is used to reduce the particle sizes.

17. A method according to claim 1, wherein a fluidic mixer is used to reduce the particle sizes.

18. A method according to claim 1, wherein a cavitation high shear mixer is used to create greater turbulence to facilitate the reduction in particle sizes.

19. A method according to claim 1, wherein prior to the addition of a surfactant, an electric current is passed through the oil-contaminated material.

20. A method according to claim 1, wherein a surfactant is added to the oil-contaminated material during the step of reducing the particle sizes.

21. A method according to claim 1, wherein solid material which has less than 1% oil by weight is capable of being discarded overboard from an oil platform or vessel onto the seabed.
